(19) United States
(12) Patent Application Publication
(10) Pub. No.: US 2022/0251924 A1
(43) Pub. Date: Aug. 11, 2022

(54) VALVE BONNET APPARATUS AND SYSTEMS AND METHODS THEREOF

(71) Applicant: Steadfast Valve Solutions,LLC, Corpus Christi, TX (US)

(72) Inventor: JEFFREY NULL, Corpus Christi, TX (US)

(73) Assignee: Steadfast Valve Solutions,LLC, Corpus Christi, TX (US)

(21) Appl. No.: 17/650,716

(22) Filed: Feb. 11, 2022

Related U.S. Application Data
(60) Provisional application No. 63/148,299, filed on Feb. 11, 2021.

(51) Int. Cl. E21B 34/02; E21B 34/16

(52) U.S. Cl. CPC E21B 34/02; E21B 43/126; E21B 34/16

(57) ABSTRACT

A valve bonnet system including an emergency shut-off feature is presented. A bonnet can include a fluid inlet and a stopper inlet. A stopper member can be coupled with the stopper inlet, and engaging of the stopper member can effectively seal a channel of the fluid inlet to prevent the egress of liquid from a valve stem cavity of the valve through the fluid inlet channel. A stopper member can include a stopper, a gland nut, and a gland collar, and the stopper can be operated via a wrench head on the stopper. These principles can be applied to existing bonnets in the art with pre-existing fluid inlets, such that these bonnets can be improved to incorporate an emergency shut-off feature.

### CROSS-REFERENCE TO RELATED APPLICATIONS

This application claims priority to U.S. Provisional Patent Application Ser. No. 63/148,299.

### STATEMENT OF FEDERALLY SPONSORED RESEARCH OR DEVELOPMENT

None.

### REFERENCE TO A SEQUENCE LISTING, A TABLE, OR A COMPUTER LISTING COMPACT DISC APPENDIX

None.

### TECHNICAL FIELD

The present disclosure relates generally to valve bonnets and systems and methods for preventing blowouts through fluid channels of bonnets, especially with respect to hydraulic fracturing valves.

### BACKGROUND

Valves are used in multiple industries that require fluid flow control. For example, in the oil and gas recovery industry, hydraulic fracturing valves are used to control the flow of fluid in fracking wells. These valves must be able to contain immense pressure (e.g. 15,000 lbs.) and be operated by engineers and crews. Generally, a valve can have a hydraulic actuator attached to a valve stem that is actuated from opened to closed (or vice-versa) by the operating assembly, and sufficient lubrication must be applied to a valve cavity within a valve such that an operator can turn the wheel to open and close the valve as needed. To facilitate this lubrication, valves often have grease channels that contact the valve stem cavity; grease can be applied through these channels to contact a valve stem, effectively lubricating the stem and dispersing particulates introduced through the stem cavity by hydraulic fracturing or other well site operations to enable the stems to be operated, operating the valve.

A grease channel is accessible from the outside of the valve, and the mouth of the channel is often affixed with a type of fitting, such as a grease fitting, or a high pressure lubrication fitting. The grease fittings are designed to be coupled within the mouth of the channel to close the channel, and subsequently be opened to allow the application of grease. Grease fittings in the art often additionally facilitate the attachment of a lubricant applicator, such as by having a type of nozzle that can be exposed when the fitting is opened. The grease fittings are additionally designed to seal the channel to prevent backflow from the valve stem cavity. However, the grease fittings are often compromised due to the high pressure of fluid in the valve, and fluid can begin to leak through the grease channel and out of the grease fitting. If left unchecked, this can lead to a valve blowout, which can cost hundreds of thousands of dollars to oil and gas recovery companies.

### SUMMARY

In one embodiment, the present disclosure includes a valve bonnet apparatus. The apparatus can include a valve stem cavity; a stopper member; a fluid inlet; and a stopper inlet. The stopper member can include a gland nut; a stopper, the stopper including a first end, a second end, and a shaft, wherein the first end is configured to couple with the gland nut; and a gland collar configured to receive the stopper. The fluid inlet can include a mouth configured to receive a fitting; and an inlet channel intersecting the valve stem cavity. The stopper inlet can include a mouth configured to couple with the gland collar, wherein the mouth is further configured to receive the gland nut; and a stopper channel intersecting the inlet channel, the stopper channel configured to receive the stopper. The second end of the stopper can be configured to plug the inlet channel.

In another embodiment, the present disclosure includes a method of modifying a valve bonnet. The method can comprise the steps of: providing a bonnet having a first inlet; fabricating a second inlet in the bonnet, the second inlet having a mouth and an inlet channel, wherein the inlet channel includes a bend; fabricating a stopper inlet in the bonnet, the stopper inlet having a mouth and a stopper channel, wherein the stopper channel intersects the inlet channel at the bend of the inlet channel; engaging a stopper member within the stopper inlet; and sealing the first inlet. Tightening of the stopper member within the stopper inlet can plug the inlet channel at the bend.

In another embodiment, the present disclosure can include a valve bonnet system. The system can comprise a valve bonnet member and a stopper member. The valve bonnet member can include a grease inlet having a mouth and a grease channel, and a stopper inlet having a mouth and a stopper channel. The stopper member can be configured to engage within the stopper inlet. The stopper member can include a gland nut; a stopper, the stopper including a first end, a second end, and a shaft, wherein the first end can configured to couple with the gland nut; and a gland collar configured to receive the stopper. The stopper member can be operable to plug the grease channel.

### BRIEF DESCRIPTION OF THE DRAWINGS

The present disclosure will be readily understood by the following detailed description, taken in conjunction with the accompanying drawings that illustrate, by way of example, the principles of the present disclosure. The drawings illustrate the design and utility of one or more exemplary embodiments of the present disclosure, in which like elements are referred to by like reference numbers or symbols. The objects and elements in the drawings are not necessarily drawn to scale, proportion, or precise positional relationship. Instead, emphasis is focused on illustrating the principles of the present disclosure.

FIG. 1A illustrates a top cross-sectional view of an exemplary valve bonnet apparatus having a first inlet, second inlet, and stopper inlet in accordance with one or more exemplary embodiments of the present disclosure;

FIG. 1B illustrates a side cross-sectional view of the valve bonnet apparatus of FIG. 1A in accordance with one or more exemplary embodiments of the present disclosure;

FIG. 1C illustrates a bonnet apparatus with a second inlet with an inlet channel having a single bend in accordance with one or more exemplary embodiments of the present disclosure;

FIG. 2A illustrates a stopper or stopper member including a head 202 and a tip 206 in accordance with one or more exemplary embodiments of the present disclosure;

FIG. 2B illustrates a gland nut configured to engage a stopper inlet mouth in accordance with one or more exemplary embodiments of the present disclosure;

FIG. 2C illustrates a gland collar configured to engage a stopper inlet mouth in accordance with one or more exemplary embodiments of the present disclosure;

FIG. 3 illustrates a valve bonnet system comprising a valve bonnet member and stopper member in accordance with one or more exemplary embodiments of the present disclosure;

FIG. 4 depicts a bonnet apparatus comprising a valve bonnet member in accordance with one or more exemplary embodiments of the present disclosure;

FIG. 5 depicts a packing in accordance with one or more exemplary embodiments of the present disclosure;

FIG. 6 depicts a hydraulic fracturing valve system comprising a bonnet member in accordance with one or more exemplary embodiments of the present disclosure.

FIG. 7 illustrates a hydraulic fracturing valve bonnet system comprising a grease inlet and a stopper inlet in accordance with one or more exemplary embodiments of the present disclosure;

FIG. 8 illustrates a hydraulic fracturing valve bonnet system in accordance with one or more exemplary embodiments of the present disclosure; and

### DETAILED DESCRIPTION

The preferred version of the disclosure presented in the following written description and the various features and advantageous details thereof, are explained more fully with reference to the non-limiting examples included in the accompanying drawings and as detailed in the description, which follows. Descriptions of well-known components have been omitted so to not unnecessarily obscure the principle features described herein. The examples used in the following description are intended to facilitate an understanding of the ways in which the disclosure can be implemented and practiced. Accordingly, these examples should not be construed as limiting the scope of the claims.

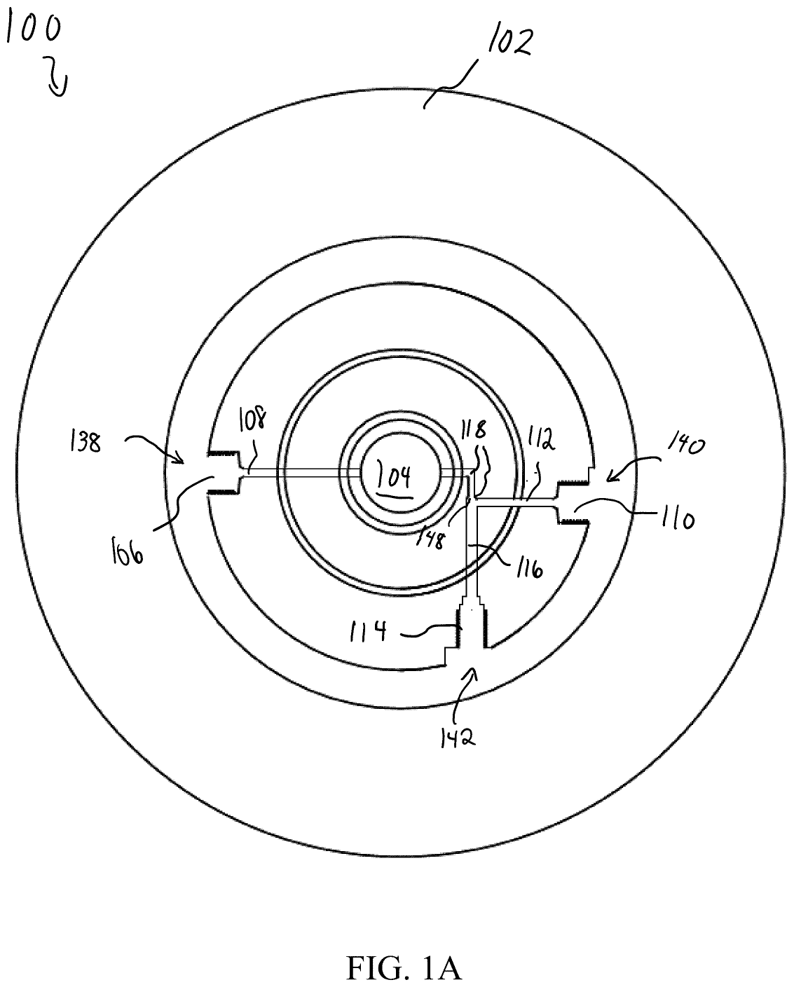

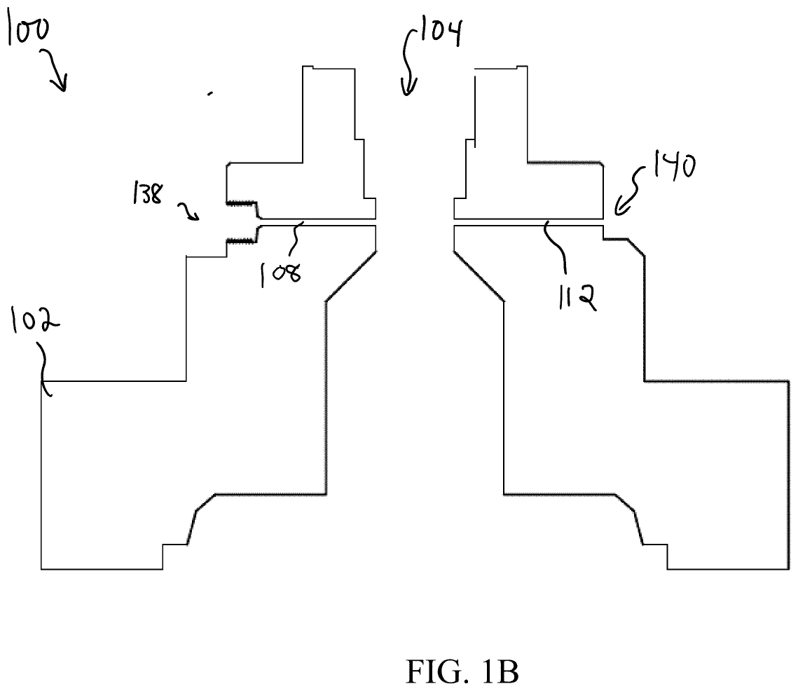

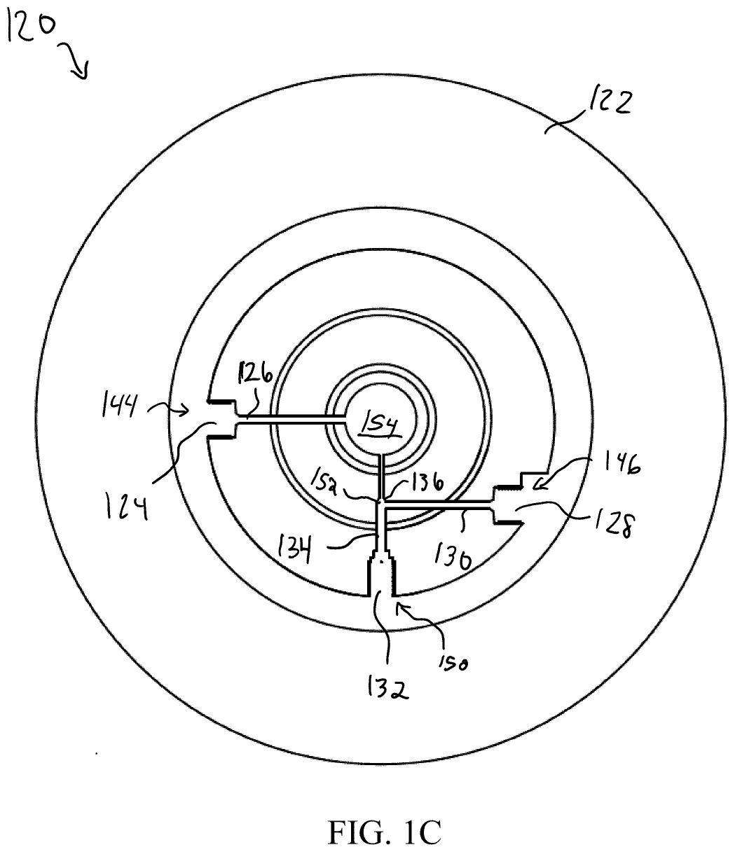

FIG. 1A illustrates a perspective view of a valve bonnet apparatus (valve bonnet system) 100 in accordance with the principles of the present disclosure. In one example, the apparatus 100 can include a bonnet 102 having a first inlet (first grease inlet) 138. The bonnet 102 can be a standard bonnet, extended bonnet, cryogenic bonnet, bellows seal bonnet, or any other bonnet known in the art. Preferably, the bonnet 102 can be a bonnet 102 used in hydraulic fracturing valves, such as those used in the oil and gas recovery industry. In another example, the first grease inlet 138 can include a mouth 106 and a (first) inlet channel (grease channel) 108. The first inlet channel 108 can intersect a valve stem cavity 104, such as to facilitate the application of grease through the first inlet 138 to a valve stem traversing the cavity 104 (the valve stem not shown in FIG. 1A). The first inlet 138 can be a grease inlet known in the art, such as those commonly found on valves known in the art, such as hydraulic fracturing valves. For example, the first grease inlet 138 can have a mouth 106 that is configured to receive a fitting (grease fitting), lubrication fitting, cap (grease cap), or any other type of seal known in the art.

In another embodiment, the apparatus 100 can include a second inlet (second grease inlet) 140. In one example, the second inlet 140 can include a mouth 110 and a (second) inlet channel (grease channel) 112. Preferably, the inlet channel 112 can include a bend 118 or bends 118 and can further connect with the valve stem cavity 104. The second inlet 140 can be any suitable inlet, including inlets known in the art, especially with respect to hydraulic fracturing. The mouth 110 of the second inlet 140 can be configured to receive a fitting, lubrication fitting, cap, or any other type of seal known in the art; preferably, the second inlet 140 mouth 110 can be configured to receive a lubrication fitting or grease fitting like those used in the field of hydraulic fracturing valves. For example, the mouth 110 can include threads (as seen in FIG. 1A) configured to engage threads on a fitting; in another example, the mouth 110 can a component in a quick-connect fitting. The mouth 110 can include any type of coupler, fastener, or other suitable mechanism to facilitate coupling with a fitting, and in this manner can be configured to engage with a fitting.

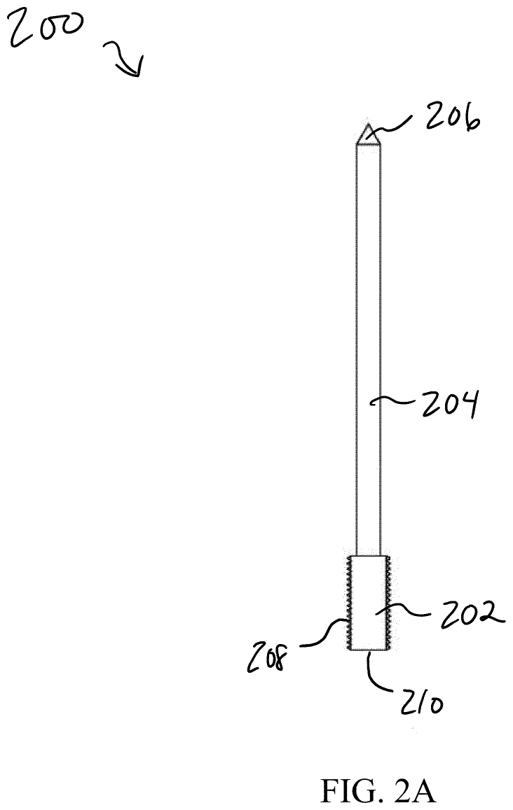

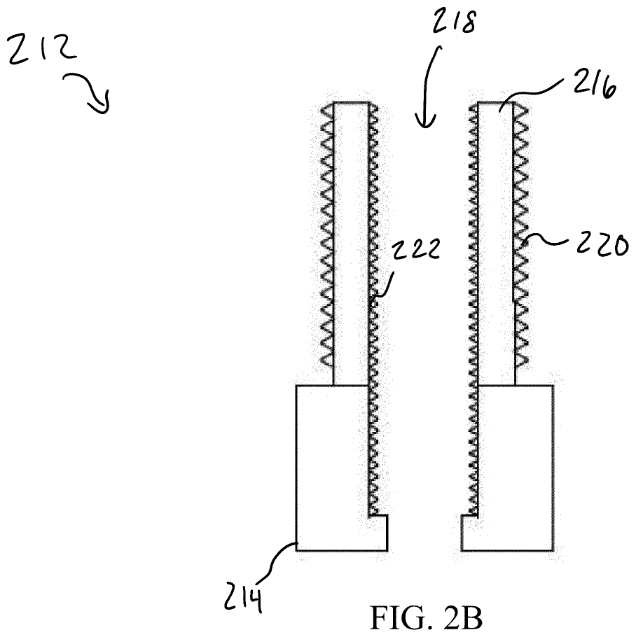

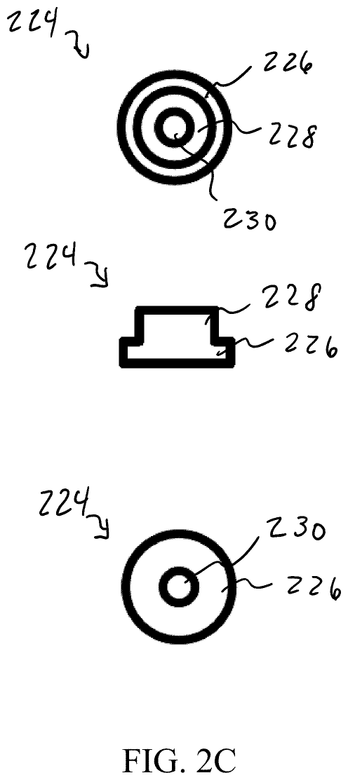

In another embodiment, the apparatus 100 can include a stopper inlet 142. In one embodiment, the stopper inlet 142 can include a mouth 114 and a stopper channel 116. The mouth 114 can be configured to engage with or couple to, for example, a stopper member or stopper apparatus; in another example, the mouth 114 can be configured to couple to any fitting, cap, etc. known in the art. In one embodiment, the mouth 114 can include threads (such as is shown in FIG. 1A) that correspond to threads on, for example, a gland nut of a stopper member, such as that shown in FIGS. 2A-2C. The stopper channel 116 can intersect with the second inlet channel 112 at the bend 118 or bends 118. Preferably, the stopper channel 116 can be configured to receive a stopper and facilitate the plugging of the second inlet channel 112. For example, at the point of intersection 148 between the second inlet channel 112 and the stopper channel 116, the channel(s) 112, 116 can be configured to receive an end of a stopper. In one example, and as depicted in FIG. 1A, the second inlet channel 112 (and encroaching stopper channel 112) can be tapered (such as into a conical form 148) at the intersection 148, and the remaining portion of the inlet channel 112 can, in one example, have a smaller diameter as compared to the portion of the channel 112 before the intersection 148. In this manner, a stopper inserted through the stopper channel 116 can engage at the intersection 148 and prevent the egress of fluid from the valve stem cavity 104 through either the second inlet channel 112 or the stopper channel 116; in this manner, a stopper inserted into the stopper channel 116 can plug the second inlet channel.

FIG. 1B depicts a perspective cross-sectional view of the valve bonnet apparatus 100 of FIG. 1A. The apparatus 100 can include a bonnet 102 having a first inlet 138 and a second inlet 140. The first inlet can have an inlet channel 108, and the second inlet can have an inlet channel 112, and one or both inlet channels 108, 112 can intersect the valve stem cavity 104.

FIG. 1C depicts another embodiment of the present disclosure. A bonnet apparatus 120 can include a bonnet 122, which can be similar to the bonnet described with respect to FIG. 1A. In one embodiment, the apparatus 120 can include a first inlet (grease inlet) 144, a second inlet (grease inlet) 146, and a stopper inlet 150. In another embodiment, the bonnet apparatus 120 can include just a first or second inlet (first or second grease inlet) and stopper inlet, as opposed to both a first and second inlet. In another embodiment, the first inlet 144 can include a mouth 124 and a first inlet channel 126 that can connect with a valve stem cavity 154. In one embodiment, the second inlet 146 can include a mouth 128 and a second inlet channel 130. The inlet channel 130 can include a bend 136, such as a single bend 136 at a substantially normal angle, and can further connect to the valve stem cavity 154 after the bend 136. In another embodiment, the bonnet apparatus 120 can include a stopper inlet 150 comprising a mouth 132 and a stopper channel 134, and the stopper channel 134 can intersect 152 with the second inlet channel 130. Similar to FIG. 1A, the intersection 152 of the inlet channel 130 and stopper channel 134 can be configured to receive a stopper, such as an end of a stopper. In another embodiment, the inlet channel 130 can itself be configured to receive a stopper, or alternatively, the stopper channel 134 can be configured to receive a stopper. Similar to FIG. 1A, the inlet channel 130 can be tapered at the bend 136 such that a conical portion 152 is formed at the intersection 152, such as to engage a stopper end that is inserted through the stopper channel 134. In this manner, the channel 130 or 134 or channels 130, 134, or intersection 152 therebetween, can be configured to receive a stopper, such as to prevent egress of fluid from the valve stem cavity through the inlet channel 130 or stopper channel 134.

FIG. 2A depicts another embodiment of the present disclosure. A stopper member (stopper apparatus) (stopper) 200 can include a first end 202, a second end 206, and a shaft 204. In one embodiment, a stopper member can include a stopper 200, a gland nut 212, and gland collar 224. In one embodiment, the second end 206 can be tapered into a point 206 or conical point 206, such as to engage within an intersection between an inlet channel and stopper channel, or to engage with a stopper channel or inlet channel like those discussed herein. In another embodiment, the first end 202 can be head 202, such as a wrench head 202, and can include a hex wrench recession, Phillips, flathead, or any other type of wrench head at, for example, position 210. In another embodiment, the first end 202 can be configured to engage with, for example, a gland nut. For example, the first end 202 can include threads 208 that can correspond to threads on a gland nut. In another embodiment, the first end 202 of the stopper member 200 can be configured to engage with a mouth of a stopper inlet, either directly or via a gland nut.

FIG. 2B depicts another embodiment of the present disclosure. A gland nut (bushing) 212 can include a first member 214, a second member 216, and a stopper cavity 218. In one embodiment, the first member 214 can be a head 214, and the second member 216 can be a hollow screw. In another embodiment, the stopper cavity 218 can traverse the length of the gland nut 212, such that the interior of the gland nut 212 is hollow. In one embodiment, the second member 216 of the gland nut 212 can be configured to engage, for example, a mouth of a stopper cavity. For example, the second member 212 can include threads 220 on an outer surface of the second member 216 that can corresponded to threads within the mouth of a stopper cavity (such as 114 or 132 from FIGS. 1A and 1C, respectively). In another embodiment, the stopper cavity 218 can be configured to engage or couple with a stopper, such as stopper 200. For example, the cavity 218 can include threads 222 that can correspond to threads on the stopper (such as threads 208 on the first end 202 of the stopper 200). In this manner, a gland nut 212 can be secured within a mouth via a coupling mechanism (e.g., threads 220 or a quick connect), and a stopper within the stopper cavity 218 can travel within the cavity 218, such as via application of torque to the stopper to engage the stopper with the threads 222 of the stopper cavity to move the stopper within the cavity 218.

FIG. 2C depicts another embodiment of the present disclosure. A gland collar 224 can include a flange 226, a collar 228, and a stopper aperture 230. In one embodiment, the gland collar 224 can be configured to sit within a stopper inlet mouth (such as mouth 114 or mouth 132). For example, a stopper inlet mouth can include a recess to receive the collar 228, and an outer rim of the recess in the mouth abut the flange 226. In another embodiment, the stopper aperture 230 can be configured to receive a stopper therethrough, and the flange 226 can abut a first end of a stopper (such as first end 202), as well as second member of a gland nut (such as second member 216).

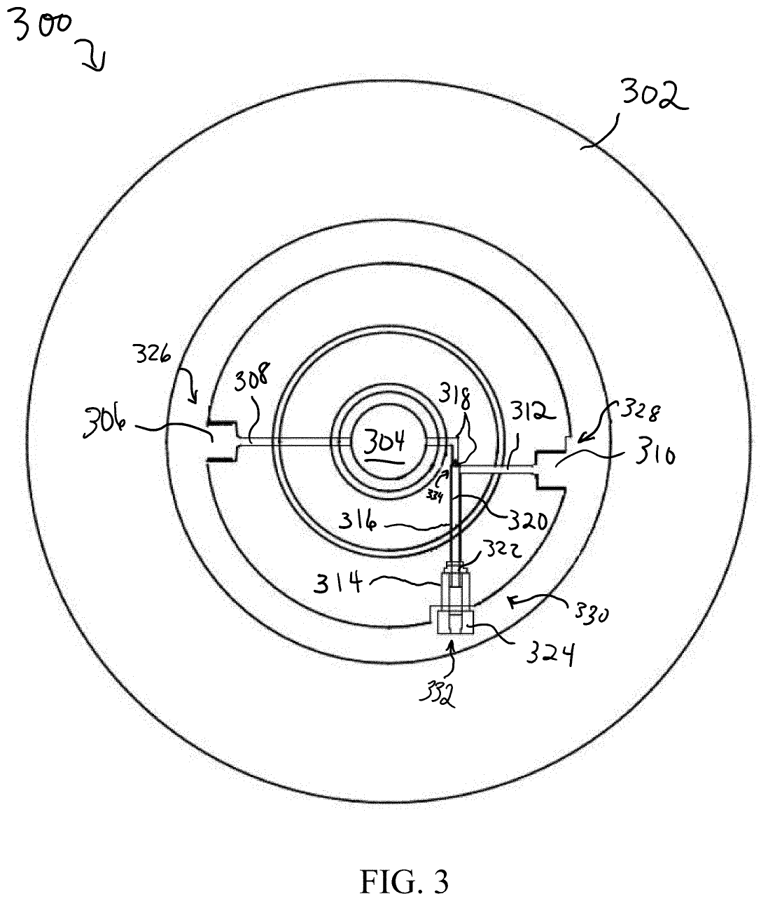

FIG. 3 depicts another embodiment of the present disclosure. A valve bonnet system 300 can include a bonnet (valve bonnet member) 302 in accordance with the principles of the present disclosure. In one embodiment, the bonnet system 300 can include a first inlet 326 comprising a mouth and a channel 308, and can then be modified to include a second inlet 328 and a stopper inlet 330 in accordance with the principles of the present disclosure. Preferably, after modification to include these inlets 328, 330, the first inlet 326 can be capped or sealed, such that fluid can be prevented from egressing out of the first inlet 326. In another embodiment, the bonnet can include just the second inlet 328 and stopper inlet 330. In one embodiment, the second inlet 328 can include a mouth 310 and an inlet channel 312, and the inlet channel can include a bend 318 or bends 318. In another embodiment, the stopper inlet 330 can include a mouth 314 and a stopper channel 316. In one embodiment, the stopper channel 316 can intersect the inlet channel 312 at the bend 318, and such as discussed with respect to FIGS. 1A and 1C, the inlet channel 312, stopper channel 316, and/or the intersection 334 therebetween can be configured to receive and engage with a stopper 320.

In one embodiment, the system 300 can further include a stopper member (stopper apparatus) 332. As an example, the stopper member 332 can include gland nut 324 (such as gland nut 212 in FIG. 2B), a gland collar 322 (such as gland collar 224 in FIG. 2C), and a stopper 320 (such as stopper 200 in FIG. 2A). In one embodiment, a stopper member 332 can engage within and/or couple to a mouth 314 of a stopper inlet 330, such as via threads (such as threads 220 in FIG. 2B), helical threads, a quick-connect mechanism, or any other securing mechanism suitable to securely attach the stopper apparatus 332 within the mouth 314 and allow the stopper 320 to move longitudinally within the stopper channel 316. In another embodiment, the gland collar 322 can engage the mouth 314 at the top of the stopper channel 316, and the stopper 320 can be inserted through the gland collar 322 and into the stopper channel 316. In one embodiment, an end of the stopper 320 (such as the first end 202 in FIG. 2A) can be configured to engage the gland nut 324, such as within a cavity of the gland nut 324 (such as stopper cavity 218 in FIG. 2B).

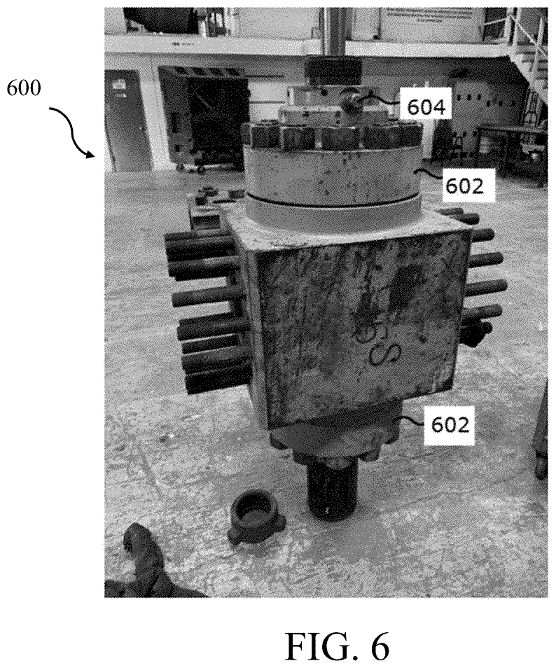

Preferably, the stopper 320 of the stopper member 332 can be operable to move longitudinally within the gland nut 324 and the stopper channel 316. In this manner, the stopper member 332 can enable the selective opening and closing of the second inlet 338. For example, the gland nut 324 can be engaged in the mouth 314 of the stopper inlet 330 (such as via threads as shown in FIG. 2B), the stopper 320 can be engaged within the gland nut 324 (such as via threads as shown in FIGS. 2A and 2B), and the gland collar 322 can be disposed between the gland nut 324 and the top of the stopper channel 316. In another embodiment, a packing (such as that shown in FIG. 6E) can be disposed between the gland collar 322 and the bonnet member 302 such that a seal can be created—the packing can take the form of an O-ring, rubber, plastic, or any other suitable material or design to create a seal between the gland collar 322 and the bonnet member 302, such as seal that can be impermeable to liquid seeking to egress out of the stopper inlet 338. In one embodiment, a wrench head at the top of the stopper 320 can be engaged, and as torque is applied, the stopper 320 can travel into the intersection 334 of the second inlet channel 312 and the stopper channel 316. In another embodiment, when the stopper 320 is tightened into the intersection 334, the tip of the stopper 320 can plug the second inlet channel 312, such as at the bend 318, to prevent the egress of fluid from the valve stem cavity 304 through the inlet channel 312. To apply a fluid to the valve stem cavity 304 through the second inlet 328 (such as when applying grease to a valve stem), the stopper 320 can be loosened and removed from the intersection 334 of the stopper channel 316 and the inlet channel 312, such that a pathway is created from the mouth 310 of the second inlet 328, through the inlet channel 312, through the bend 318, and into the valve stem cavity 304.

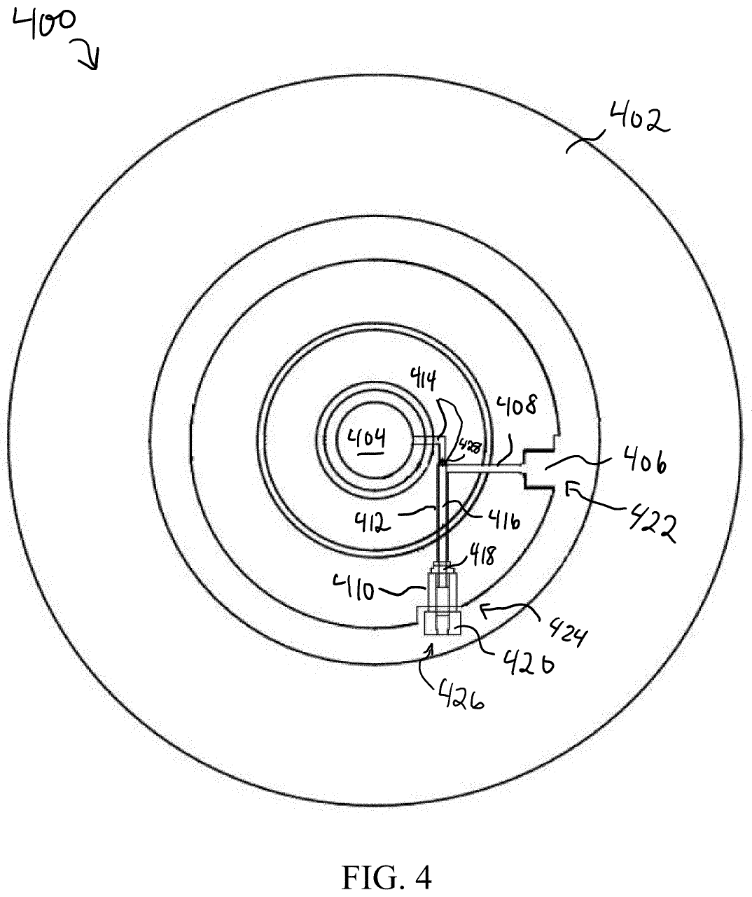

FIG. 4 depicts another embodiment of the present disclosure, wherein a bonnet apparatus 400 can include a bonnet (valve bonnet member) 402 with a fluid inlet 422 and a stopper inlet 424. Similar to the FIG. 3, a stopper member 426 can be engaged within the stopper inlet 424 such that a stopper 416 can travel longitudinally within a stopper channel 412 of the stopper inlet 424, such as to plug a fluid inlet channel 408 at an intersection 428 of the fluid inlet channel 408 and the stopper channel 412, or at a bend 414 of the fluid inlet channel 408. The stopper member can include a stopper 416, a gland collar 418, and a gland nut 420; alternatively, the stopper member 426 can include only one, or only two, of these components. Similar to FIG. 3, the stopper member 426 can be loosened such that the stopper 416 can be removed from the intersection 428 and allow fluid flow between the valve stem cavity 404 and the mouth 406 of the fluid inlet 422. In one embodiment, the bonnet apparatus 400 can be designed to withstand up to 15,000 lbs. of pressure, or alternatively, prevent backflow from the stem cavity 404 through a fluid inlet channel 408 when the backflow is attempting to exist at a pressure of up to 15,000 lbs.

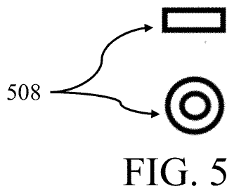

FIG. 5 depicts a preferred embodiment of the present disclosure. A stopper packing 508 can be disposed between, for example, a gland collar and a bonnet member. In another embodiment, a packing 508 can include a stopper hole configured to surround a stopper (such as stoppers disclosed herein) such that a seal can be created between the stopper and the packing 508. In one embodiment, a packing 508 can be disposed within a mouth of an inlet between a gland collar and a bonnet and can receive a stopper therethrough. When a stopper member (such as with an accompanying gland nut) is engaged within the mouth, the packing 508 can create a seal between the gland collar and the bottom of the mouth when the stopper member is installed. The encircling of the stopper by the packing 508 can similarly create a seal, such as a seal that can be impermeable to fluids.

FIG. 6 depicts another embodiment of the present disclosure, wherein a hydraulic fracturing valve system 600 can include bonnet apparatuses (bonnets) 602. In one embodiment, one or both of the bonnets 602 can be a bonnet apparatus like those discussed herein. In another embodiment, one or both bonnets 602 can include a grease inlet fitted with a grease fitting 604, such as those known in the art that can facilitate the coupling of a lubricant applicator to apply grease to a valve stem within a bonnet cavity of the bonnet 602.

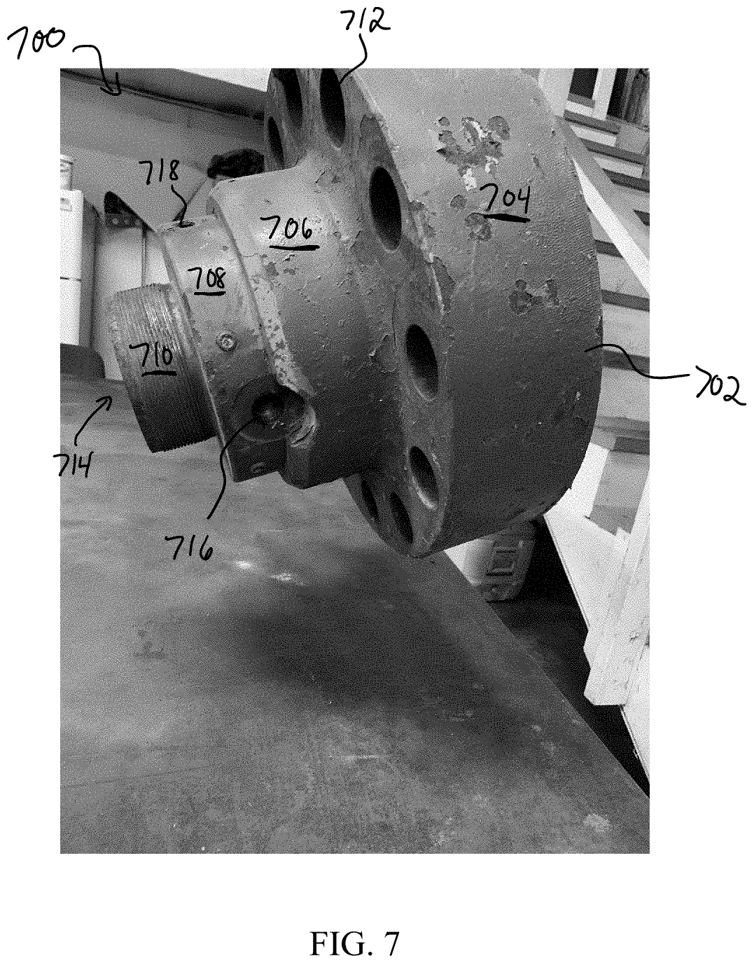

FIG. 7 depicts an embodiment of the present disclosure that includes a terraced, or tiered structure. A hydraulic fracturing valve bonnet system 700 can include a bonnet apparatus 702. The apparatus 702, in one embodiment, can include a first tier 704, second tier 706, third tier 708, a fourth tier 710, and a valve stem cavity 714. The bonnet apparatus may be forged, machined, or any combination thereof from a ferrous or other suitable alloy. The bonnet apparatus may also be a monolithic structure, such that it is comprised of a single piece of material. In another embodiment, the first tier 704 can include bolt holes 712 or any other mechanism suitable to couple the apparatus 702 to a valve. In one embodiment, the apparatus 702 can include a grease inlet 716, which can be similar to the inlets discussed with respect to FIGS. 1A, 1C, 3, 4, etc. The inlet 716 can include a mouth operable to receive, for example, a grease fitting, such as grease fittings known in the art that can enable the coupling of a grease applicator to apply grease to the valve stem cavity 714 and subsequently be closed to prevent egress of fluid from the cavity 714 through the grease inlet. In another embodiment, the apparatus 702 can include a stopper inlet 718 into which a stopper member can be installed—the stopper member can be similar to those discussed herein. In another embodiment, the grease inlet 716 can be fabricated such that it is contained primarily in the third tier 708 of the apparatus 702. For example, a channel of the grease inlet 716 can be substantially planar with the third tier 708, such that grease can be applied to a valve stem within the cavity 714 near the top of the bonnet apparatus 702. In another embodiment, the stopper inlet 718 can similarly be located substantially within the third tier 708, such that a channel of the stopper inlet 718 can be substantially planar with the third tier 708 to facilitate intersection of the stopper inlet 718 channel with the grease inlet 716 channel.

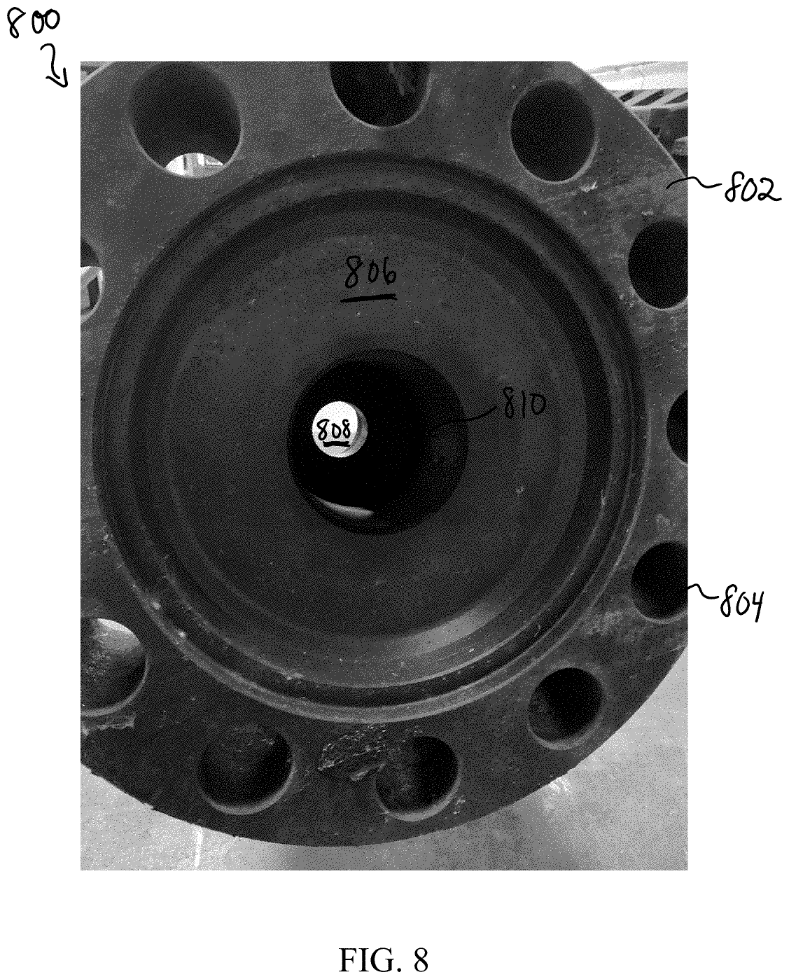

FIG. 8 depicts another embodiment of the present disclosure, wherein a hydraulic fracturing valve bonnet system 800 can include a bonnet apparatus 802. The apparatus 802 can include bolt holes 804 to facilitate coupling of the apparatus 802 to a valve. The apparatus can further include a recessed portion 806 operable to engage with a valve. The apparatus 802 can further include a valve stem cavity 808 capable of coupling a valve stem. In one embodiment, a grease channel can access the cavity 808 at, for example, location 810.

The apparatuses, systems, and methods disclosed herein can be used to prevent valve blowouts, or otherwise stem the flow of fluid from a valve stem cavity out of an inlet. For example, a bonnet system like those disclosed herein with a fluid inlet and a stopper inlet can be installed on a valve. Additionally, or alternatively, multiple bonnets as described herein may be used on a single valve. A stopper member can be installed within a stopper inlet, but the stopper of the stopper member can be “loose,” such that a valve stem cavity of the bonnet and a channel of the fluid inlet are in fluid communication. In one embodiment, a grease fitting can be couple to a mouth of the fluid inlet. With the stopper “loose,” the grease fitting can be uncovered to expose a lubricant applicator attachment, such that a lubricant applicator can be coupled to the grease fitting to allow grease to be pumped into the valve. Because the stopper is loose, grease can be pumped from the mouth of the fluid inlet, through the inlet channel, and into the valve stem cavity, such as to apply grease to a valve stem within the cavity. Once the grease has been applied, the grease fitting can be closed. If pressure builds up in the valve such that fluid begins to flow out of the fluid inlet, the stopper can then be tightened, effectively plugging the inlet channel between the valve stem cavity and mouth of the fluid inlet, preventing or mitigating the flow of fluid out through the fluid inlet.

In another embodiment, the apparatuses, systems, and methods disclosed herein can be used to modify existing valve bonnets. For example, a valve bonnet including a first inlet can be modified to include a second inlet and stopper inlet in accordance with the principles of the present disclosure. In one embodiment, the first inlet can then be capped (such as with a grease cap), or effectively sealed, or permanently sealed. In another embodiment, lubricant can then be applied through the second inlet instead of through the first inlet. In this manner, a bonnet can be improved by modifying the bonnet to be operable to receive a stopper member in the stopper inlet, such that the stopper member can be engaged to prevent backflow of fluid through the second inlet. Fluid backflow through the first inlet can likewise be prevented by sealing the first inlet. In this manner, the stopper inlet and accompanying stopper member can be considered an emergency shut-off measure, engageable when the valve begins to leak. In one embodiment, operation of the stopper member can be manual; in another embodiment, operation of the stopper member can be automated.

The present disclosure achieves at least the following advantages:

1. Preventing valve blowouts by providing a method of plugging a fluid inlet channel;

2. Improving valve integrity by providing a bonnet with redundant leak-prevention measures (i.e. a stopper member in combination with a grease fitting);

3. Significant cost savings resulting from reduced valve leakage and blowouts;

4. Improvement to existing valve bonnets; and

5. A stopper member in a valve bonnet that is selectively engageable to prevent further leakage once a leak has begun.

Persons skilled in the art will readily understand that these advantages (as well as the advantages indicated in the summary) and objectives of this system would not be possible without the particular combination of computer hardware and other structural components and mechanisms assembled in this inventive system and described herein. It will be further understood that a variety of programming tools, known to persons skilled in the art, are available for implementing the control of the features and operations described in the foregoing material. Moreover, the particular choice of programming tool(s) may be governed by the specific objectives and constraints placed on the implementation plan selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f).

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the inventions can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A valve bonnet apparatus, the apparatus comprising:
a bonnet body;
a valve stem cavity disposed through the bonnet body;
a stopper member including:
a gland nut;
a stopper, the stopper including a first end, a second end, and a shaft, wherein the first end is configured to couple with the gland nut; and
a gland collar configured to receive the stopper;
a first fluid inlet disposed through the bonnet body including:
a mouth disposed on the outer surface of the bonnet body configured to receive a fitting; and
an inlet channel providing fluid communication between the mouth and the valve stem cavity; and
a stopper inlet including:
a mouth disposed on the outer surface of the bonnet body configured to couple with the gland collar, wherein the mouth is further configured to receive the gland nut; and
a stopper channel intersecting the inlet channel, the stopper channel configured to receive the stopper;
wherein the second end of the stopper is configured to plug the inlet channel.

2. The valve bonnet apparatus of claim 1, wherein the fluid inlet comprises at least a first bend between the mouth and the valve stem cavity.

3. The valve bonnet apparatus of claim 2, wherein the stopper inlet channel comprises tapered walls.

5. The valve bonnet apparatus of claim 2, wherein the stopper member second end comprises a tapered tip for engagement with one of the stopper inlet channel or the inlet channel of the first fluid inlet.

6. The valve bonnet apparatus of claim 2, wherein the stopper channel intersects the inlet channel at the bend in the fluid inlet channel.

7. The valve bonnet apparatus of claim 1, further comprising a second fluid inlet including:
a second mouth configured to receive a fitting; and
a second inlet channel providing fluid communication between to the valve stem cavity.

8. A method of modifying a valve bonnet, the method comprising the steps of:
providing a bonnet having a first fluid inlet and a stopper inlet, wherein the first fluid inlet and the stopper inlet intersect, and wherein the first fluid inlet has at least one bend at a point beginning at the intersection of the first fluid inlet and the stopper inlet and ending at the valve cavity;
inserting a stopper member in the stopper inlet;
engaging a stopper member within the stopper inlet; and
sealing the first inlet;
wherein tightening of the stopper member within the stopper inlet plugs the inlet channel at the bend.

9. A valve bonnet system, the system comprising:
a valve bonnet member having a body including a valve cavity disposed therethrough;
a grease inlet having a mouth and a grease channel;
a stopper inlet having a mouth and a stopper channel; and
a stopper member configured to engage within the stopper inlet, the stopper member including:
a gland nut;
a stopper, the stopper including a first end, a second end, and a shaft, wherein the first end is configured to couple with the gland nut; and
a gland collar configured to receive the stopper;
wherein the stopper member is operable to seal the grease channel.

10. The valve bonnet system of claim 9, wherein the valve bonnet member body is comprised of multiple substantially terraced tiers about the valve cavity, such that a first tier is operable to be affixed to a valve assembly, and wherein at least a second substantially concentric tier is smaller in diameter to the first tier disposed adjacent to the first tier.

11. The valve bonnet system of claim 10, further comprising a third substantially concentric tier is smaller than the second tier, and is disposed adjacent to the second tier.

12. The valve bonnet system of claim 11, wherein the stopper inlet is disposed through a wall of the third tier, and wherein the grease inlet is disposed through one of (a) the exterior wall of the second tier, (b) the exterior wall of the third tier; or (c) at least a portion of the exterior walls of the second and third tier.

13. The valve bonnet system of claim 12, wherein the stopper inlet channel intersects the grease inlet channel within the body of the valve bonnet member.

14. The valve bonnet system of claim 9, wherein the valve bonnet member body comprises a monolithic structure.

15. The valve bonnet system of claim 10, wherein the first tier of the valve bonnet member comprises a recessed portion to facilitate engagement with a valve assembly.

16. The valve bonnet system of claim 10, wherein the first tier of the valve bonnet member comprises bolt holes to facilitate engagement with a valve assembly.

17. A valve bonnet apparatus, the apparatus comprising:
a bonnet body;
a valve stem cavity disposed through the bonnet body;
a stopper member including:
a gland nut;
a stopper, the stopper including a first end, a second end, and a shaft, wherein the first end is configured to couple with the gland nut; and
a gland collar configured to receive the stopper;
a first fluid inlet disposed through the bonnet body, including:
a first inlet mouth on an outer surface of the bonnet body configured to receive a fitting; and
a first inlet channel providing fluid communication between the mouth and the valve stem cavity;
a second fluid inlet disposed through the bonnet body, including:
a second inlet mouth on an outer surface of the bonnet body configured to receive a fitting; and
a second inlet channel providing fluid communication between the mouth and the valve stem cavity;
a stopper inlet disposed through the bonnet body, including:
a stopper mouth configured to couple with the gland collar, wherein the mouth is further configured to receive the gland nut; and
a stopper channel intersecting the inlet channel, the stopper channel configured to receive the stopper;
wherein the second end of the stopper is configured to seal at least one of the first and second inlet channels, and further wherein:
the stopper channel intersects one of the first inlet channel or the second inlet channel.

18. The valve bonnet assembly of claim 17, wherein at least one of the first inlet channel and the second inlet channel comprises a bend between the first inlet mouth and the valve stem cavity and the second inlet mouth and the valve stem cavity, respectively, and
wherein the stopper channel intersects at least one of the first inlet channel and second inlet channel.

19. The valve bonnet assembly of claim 17, wherein at least one of the first inlet channel and the second inlet channel comprises two bends between the first inlet mouth and the valve stem cavity and the second inlet mouth and the valve stem cavity, respectively.

20. The valve bonnet assembly of claim 18, wherein the stopper member is configured to seal at least one of the first and second inlet channels at the intersection of the stopper channel.
